(19) United States
(12) Patent Application Publication
(10) Pub. No.: US 2024/0311842 A1
(43) Pub. Date: Sep. 19, 2024

(54) CUSTOMER SERVICE ASSISTANCE DEVICE, CUSTOMER SERVICE ASSISTANCE METHOD, AND RECORDING MEDIUM

(71) Applicant: NEC Corporation, Minato-ku, Tokyo (JP)

(72) Inventor: Yasuki Mochizuki, Tokyo (JP)

(73) Assignee: NEC Corporation, Minato-ku, Tokyo (JP)

(21) Appl. No.: 18/571,912

(22) PCT Filed: Jun. 25, 2021
(86) PCT No.: PCT/JP2021/024211

§ 371 Date: Dec. 19, 2023

(51) Int. Cl. G06Q 30/016

(52) U.S. Cl. CPC G06Q 30/016

(57) ABSTRACT

In the present disclosure, in order to reduce a decrease in a degree of customer satisfaction caused by wait time from an inquiry made by a customer to a response made by a service person, a customer service assistance device includes: a priority determination means for determining, based on requirement information indicating a requirement of an inquiry from a customer, a priority of a response to the inquiry; a list control means for storing identification information of the inquiry for which the priority is determined in a standby list according to the determined priority, the standby list being a list of the identification information of the inquiry awaiting a response, from among standby lists provided for each of the priority; and a display control means for causing a display means to display a screen providing priority information indicating the identification information stored in each of the standby lists.

### TECHNICAL FIELD

The present invention relates to a customer service assistance device and the like.

### BACKGROUND ART

When any problem occurs in a service provided by a service provider, a customer may make an inquiry to the service provider. In such a case, the customer makes an inquiry in order to immediately consult. Therefore, a matter that an inquiry is quickly solved leads to an increase in service quality. The service indicates, for example, selling of a tangible or intangible product, provision of labor, or the like.

As a contact point where a customer communicates with a service provider, for example, a face-to-face channel and a non-face-to-face channel are known. The face-to-face channel is a face-to-face contact point, and the non-face-to-face channel is a non-face-to-face contact point. A form of the face-to-face channel includes questions and answers in a store of a service provider. A form of the non-face-to-face channel includes questions and answers by a phone call to a store of a service provider, questions and answers by a phone call to a call center of a service provider, questions and answers at a web inquiry window of a service provider, questions and answers at a chat reception window of a service provider, and the like.

With regard to the form of the non-face-to-face channel, in questions and answers at a web inquiry window and questions and answers at a chat reception window, a requirement can be declared when an inquiry is started and the inquiry is temporarily accepted. However, time may be required until a customer acquires an answer from a service provider.

Similarly, with regard to the form of the non-face-to-face channel, in questions and answers by a phone call to a call center, a telephone is operated in accordance with a voice guidance for an inquiry enabling an automatic response, and thereby a customer immediately acquires an answer. However, when a customer and an inquiry service person directly talk with each other, the customer may wait for a long time until a talk is made possible. In this case, wait time is not previously clear, and therefore precious time of the customer is wasted and the customer also feels stressed. In addition, a phone call may be disconnected since the customer cannot wait until a talk is made possible. As a result, an image held by the customer for the service provider is worsen and then, the customer may be lost.

In order to shorten wait time, it is conceivable that the number of inquiry service persons is increased. However, in this case, a labor cost is increased. Therefore, a balance between quality of a service and a cost is an issue. One example of a technique in which a balance between quality of a service and a cost is considered is disclosed, for example, in PTL 1.

PTL 1 describes that a primary service person receives a question of a customer, retrieves a case database, and issues an answer to the customer; and when any solution cannot be acquired by the primary service person, a response request is issued to a secondary service person and a response made by the secondary service person is reflected in the case database.

In the method of PTL 1, a response is provided based on a past case. Therefore, in the method, time required until a problem is solved can be shortened. As a result, wait time until a talk with a service person is made possible can be shortened and the number of service persons can be reduced. In this manner, according to the method, while a cost increase is reduced, service quality can be increased.

### CITATION LIST

### Patent Literature

[PTL 1] Japanese Unexamined Patent Application Publication No. 2001-338121

### SUMMARY OF INVENTION

### Technical Problem

However, with regard to the method of PLT 1, it is desirable that wait time until a talk with a service person is made possible is further shortened.

In the method of PTL 1, a response to an inquiry is provided in order of occurrence of an inquiry. At that time, the inquiry includes an inquiry in which a customer is emotional, an inquiry including a content in which a response is time-consuming, and the like. When such an inquiry is responded to in order of occurrence, a degree of customer satisfaction is decreased when wait time from the inquiry to the response is prolonged. When, for example, wait time for an inquiry from a customer feeling emotional is prolonged, the emotion of the customer is worsened, and as a result, it is likely that an image for a service provider decreases and customer defection arises. In addition, when an emotion of the customer is worsened, a response time is further prolonged, and as a result, wait time for responses as a whole may be increased.

An object of the present invention is to provide a customer service assistance device and the like capable of reducing a decrease in a degree of customer satisfaction caused by wait time from an inquiry made by a customer to a response made by a service person.

### Solution to Problem

According to one aspect of the present invention, a customer service assistance device includes: a priority determination means for determining, based on requirement information indicating a requirement of an inquiry from a customer, a priority of a response to the inquiry; a control means for storing identification information of the inquiry for which the priority is determined in a standby list according to the determined priority, the standby list being a list of the identification information of the inquiry awaiting a response, from among standby lists provided for each of the priority; and a display control means for causing a display means to display a screen providing priority information indicating the identification information stored in each of the standby lists.

According to another aspect of the present invention, a customer service assistance method includes: determining, based on requirement information indicating a requirement of an inquiry from a customer, a priority of a response to the inquiry; storing identification information of the inquiry for which the priority is determined in a standby list according to the determined priority, the standby list being a list of the identification information of the inquiry awaiting a response, from among standby lists provided for each of the priority; and causing a display means to display a screen providing priority information indicating the identification information stored in each of the standby lists.

According to another aspect of the present invention, a customer service assistance device program recorded in a computer-readable recording medium causes a computer to achieve: a priority determination function of determining, based on requirement information indicating a requirement of an inquiry from a customer, a priority of a response to the inquiry; a list control function of storing identification information of the inquiry for which the priority is determined in a standby list according to the determined priority, the standby list being a list of the identification information of the inquiry awaiting a response, from among standby lists provided for each of the priority; and a display control function of causing a display means to display a screen providing priority information indicating the identification information stored in each of the standby lists.

### Advantageous Effects of Invention

According to the present invention, a decrease in a degree of customer satisfaction caused by wait time from an inquiry made by a customer to a response made by a service person can be reduced.

### BRIEF DESCRIPTION OF DRAWINGS

FIG. 1 is a diagram illustrating a configuration example of a customer service assistance device according to a first example embodiment of the present invention.

FIG. 2 is a diagram illustrating an operation example of the customer service assistance device according to the first example embodiment of the present invention.

FIG. 3 is a diagram illustrating an operation example of the customer service assistance device according to the first example embodiment of the present invention.

FIG. 4 is a diagram illustrating a configuration example of a system including a customer service assistance device according to a second example embodiment of the present invention.

FIG. 5 is a diagram illustrating a configuration example of the customer service assistance device according to the second example embodiment of the present invention.

FIG. 6 is a diagram illustrating an example of priorities determined by the customer service assistance device according to the second example embodiment of the present invention.

FIG. 7 is a diagram illustrating an example of a priority information image displayed in a display means by the customer service assistance device according to the second example embodiment of the present invention.

FIG. 8 is a diagram illustrating an example of an inquiry information image displayed in the display means by the customer service assistance device according to the second example embodiment of the present invention.

FIG. 9 is a diagram illustrating an example of a service person image displayed in the display means by the customer service assistance device according to the second example embodiment of the present invention.

FIG. 10 is a diagram illustrating an example of a response continuation list image displayed in the display means by the customer service assistance device according to the second example embodiment of the present invention.

FIG. 11 is a diagram illustrating an example of a response continuation detail image displayed in the display means by the customer service assistance device according to the second example embodiment of the present invention.

FIG. 12 is a diagram illustrating an example of a determination rule in priority determination based on the customer service assistance device according to the second example embodiment of the present invention.

FIG. 13 is a diagram illustrating a determination rule in priority determination based on the customer service assistance device according to the second example embodiment of the present invention.

FIG. 14 is a diagram illustrating an operation example of the system including the customer service assistance device according to the second example embodiment of the present invention.

FIG. 15 is a diagram illustrating an operation example of the customer service assistance device according to the second example embodiment of the present invention.

FIG. 16 is a diagram illustrating an operation example of the customer service assistance device according to the second example embodiment of the present invention.

FIG. 17 is a diagram illustrating an operation example of the customer service assistance device according to the second example embodiment of the present invention.

FIG. 18 is a diagram illustrating a hardware configuration according to each example embodiment of the present invention.

### EXAMPLE EMBODIMENT

### First Example Embodiment

A first example embodiment according to the present invention is described. A specific example of a customer service assistance device 10 according to the first example embodiment is a customer service assistance device 20 according to a second example embodiment to be described later.

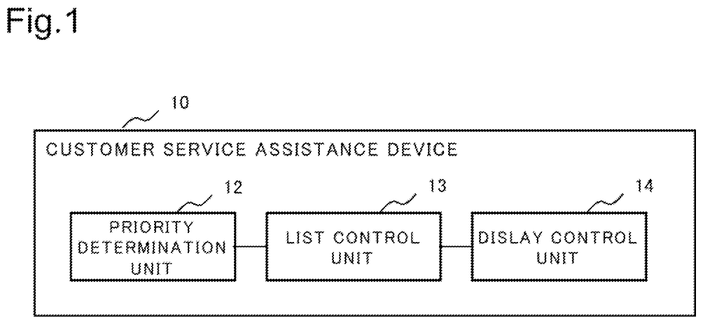

FIG. 1 illustrates a configuration example of the customer service assistance device 10 according to the present example embodiment. The customer service assistance device 10 according to the present example embodiment includes a priority determination unit 12, a list control unit 13, and a display control unit 14.

The priority determination unit 12 determines, based on requirement information, a priority of a response to an inquiry. The requirement information indicates a requirement of an inquiry from a customer.

The list control unit 13 stores, in a standby list according to a determined priority, identification information of an inquiry for which a priority is determined. The standby list is a list of identification information of inquiries awaiting a response. The standby list is provided for each priority.

The display control unit 14 causes a display means to display a screen providing priority information. The priority information indicates identification information stored in each standby list.

The customer service assistance device 10 is configured in this manner, and thereby the priority determination unit 12 determines, based on requirement information, a priority of a response to an inquiry. The list control unit 13 stores, in a standby list according to a determined priority, identification information of an inquiry for which a priority is determined. The display control unit 14 causes the display means to display a screen providing priority information. Thereby, based on priority information, a service person can select an inquiry to be responded to, and therefore an inquiry having high priority is preferentially responded to. An inquiry in which wait time is prolonged and as a result, a degree of customer satisfaction is highly likely to decrease is preferentially responded to as an inquiry having high priority. Therefore, a decrease in a degree of customer satisfaction caused by wait time from an inquiry made by a customer to a response made by a service person can be reduced.

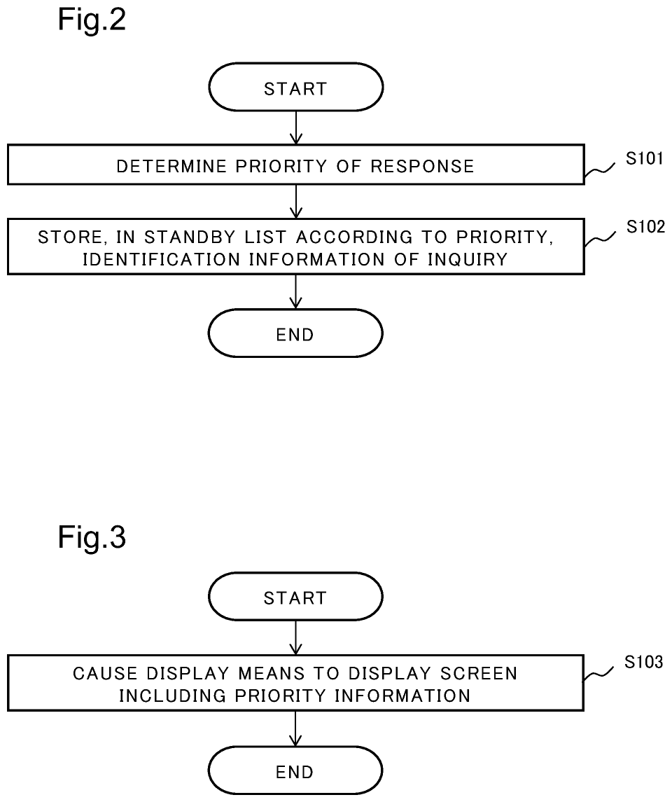

An example of an operation of the customer service assistance device 10 is described in FIGS. 2 and 3. FIG. 2 illustrates an operation example until when identification information of an inquiry is stored in a standby list. FIG. 3 illustrates an example of an operation regarding the display control unit 14.

The priority determination unit 12 determines, based on requirement information, a priority of a response to an inquiry (step S101).

The list control unit 13 stores, in a standby list according to a determined priority, identification information of an inquiry in which a priority is determined (step S102).

The display control unit 14 causes the display means to display a screen providing priority information (step S103). The display control unit 14 is able to execute step S103, independently of step S101 and step S102.

The customer service assistance device 10 operates in this manner and thereby, determines, based on requirement information, a priority of a response to an inquiry. The customer service assistance device 10 stores, in a standby list according to the determined priority, identification information of an inquiry for which a priority is determined. The customer service assistance device 10 causes the display means to display a screen providing priority information. Therefore, a decrease in a degree of customer satisfaction caused by wait time from an inquiry made by a customer to a response made by a service person can be reduced.

As described above, according to the first example embodiment of the present invention, the customer service assistance device 10 includes the priority determination unit 12, the list control unit 13, and the display control unit 14. The priority determination unit 12 determines, based on requirement information, a priority of a response to an inquiry. The list control unit 13 stores, in a standby list according to a determined priority, identification information of an inquiry for which a priority is determined. The display control unit 14 causes the display means to display a screen providing priority information. Thereby, based on the priority information, a service person can select an inquiry to be responded to, and therefore an inquiry having high priority is preferentially responded to. An inquiry in which wait time is prolonged and as a result, a degree of customer satisfaction is highly likely to decrease is preferentially responded to as an inquiry having high priority. Therefore, a decrease in a degree of customer satisfaction caused by wait time from an inquiry made by a customer to a response made by a service person can be reduced.

### Second Example Embodiment

Next, the customer service assistance device 20 according to the second example embodiment of the present invention is described. According to the present example embodiment, the customer service assistance device 20 is used for an inquiry response in a call center.

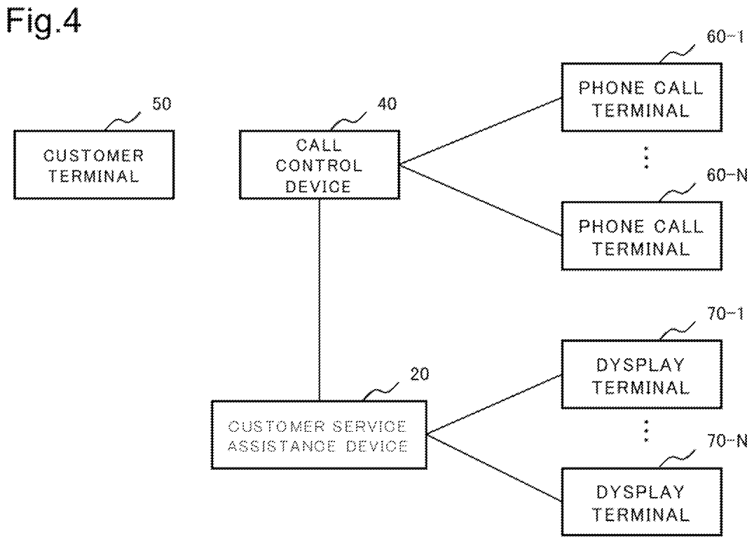

First, FIG. 4 illustrates a configuration example of a system including the customer service assistance device 20 according to the present example embodiment. The customer service assistance device 20 and a call control device 40 are connected to each other. The customer service assistance device 20 and a display terminal 70-i (i is an integer equal to or more than 1 and equal to or less than N) are connected to each other. The call control device 40 and a phone call terminal 60-i are connected to each other.

A customer terminal 50 is a terminal used for an inquiry made by a customer to a call center. The customer terminal 50 is, for example, a telephone used by a customer. An outgoing call made by the customer terminal 50 to the call center is received by the call control device 40.

The phone call terminal 60-i is a terminal used for a phone call with a customer by a service person responding to an inquiry. The phone call terminal 60-i includes at least a phone call function. According to the present example embodiment, it is assumed that one service person uses one phone call terminal.

The display terminal 70-i displays information relating to an inquiry. The display terminal 70-i includes, for example, a display or the like as an output device. The display terminal 70-i is relevant to the display means according to the first example embodiment. According to the present example embodiment, the display terminal 70-i further inputs, to the customer service assistance device 20, an instruction in accordance with operation input of a service person. The display terminal 70-i may be unified with the phone call terminal 60-i. According to the present example embodiment, it is assumed that one service person uses one display terminal. Information of a display terminal and a phone call terminal being used by a service person is stored, as information of the service person, in the storage unit 25 of the customer service assistance device 20.

The call control device 40 transfers a phone call from a customer to the customer service assistance device 20 or the phone call terminal 60-i. The call control device 40 transfers, when there is an incoming call from the customer terminal 50, the call to the customer service assistance device 20. The call control device 40 holds a specified call when receiving a hold instruction from the customer service assistance device 20. The call control device 40 transfers, when receiving, from the customer service assistance device 20, a transfer instruction of a call to the phone call terminal 60-i, a call to be transferred to a specified phone call terminal 60-i. The call control device 40 is able to perform control enabling a phone call between the customer terminal 50 and two or more, i.e., a plurality of phone call terminals.

The customer service assistance device 20 assists customer services. The customer service assistance device 20 according to the present example embodiment is included in a reception system in a call center. The customer service assistance device 20 may be included in a reception system at a web inquiry window and a chat inquiry window.

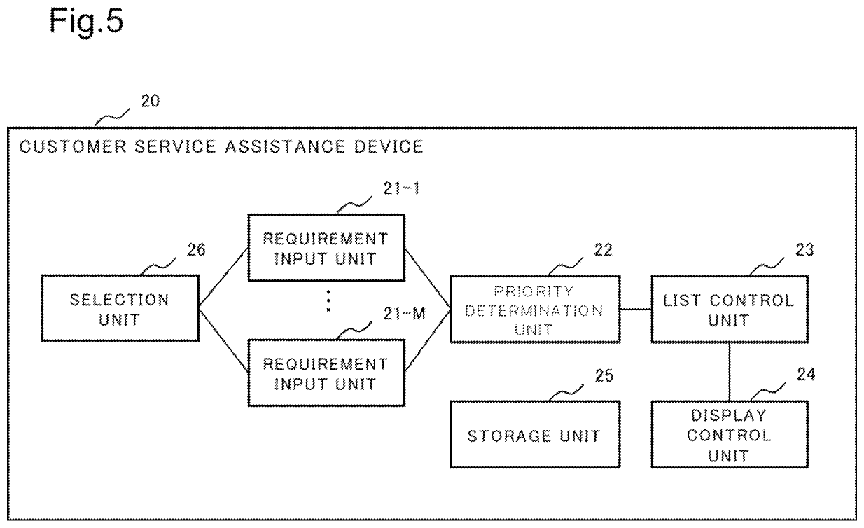

Next, FIG. 5 illustrates a configuration example of the customer service assistance device 20 according to the present example embodiment. The customer service assistance device 20 according to the present example embodiment includes a selection unit 26, a requirement input unit 21-j (j is an integer equal to or more than 1 and equal to or less than M), a priority determination unit 22, a list control unit 23, a display control unit 24, and a storage unit 25.

The selection unit 26 is connected to the requirement input unit 21-j (j is an integer equal to or more than 1 and equal to or less than M). The priority determination unit 22 is connected to the requirement input unit 21-j and the list control unit 23. The display control unit 24 is connected to the list control unit 23.

The selection unit 26 selects, when a call is transferred from the call control device 40, a requirement input unit being not handling a call from among a requirement input unit 21-1 to a requirement input unit 21-M. The selection unit 26 transfers the call to the selected requirement input unit 21-j.

The requirement input unit 21-j prompts, when a call is transferred, a customer to input a customer identification (ID) and a requirement. The requirement input unit 21-j issues identification information (inquiry ID) of an inquiry and stores, in the storage unit 25, the inquiry ID and inquiry information in association with each other. The inquiry information is information relating to an inquiry. The inquiry information includes requirement information indicating a requirement of the inquiry. The inquiry information may include customer information. The customer information is information relating to a customer such as a customer ID and a name. The requirement input unit 21-j notifies the priority determination unit 22 of the inquiry ID.

The requirement input unit 21-j performs questions and answers for an inquiry, for example, based on an automatic response by artificial intelligence (AI). The requirement input unit 21-j prompts a customer to utter an ID for a contract, a name, a phone number, an address, a requirement, and the like. The requirement input unit 21-j converts a voice input from the customer terminal 50 into characters and generates requirement information. The requirement input unit 21-j stores, in the storage unit 25, voice information of the input voice in association with an inquiry ID. The requirement input unit 21-j instructs, when questions and answers are completed, the call control device 40 to hold a call.

In a case of an inquiry based on a web and chat, a requirement is input as characters. Therefore, the requirement input unit 21-j handles input character information as requirement information.

In this manner, according to the present example embodiment, the requirement input unit 21-j performs, based on an automatic response function by AI, questions and answers for an inquiry. A response based on AI is employed and therefore, the requirement input unit 21-j is able to complete questions and answers in a shorter time than in a case where a person acquires a requirement through questioning. Therefore, the requirement input unit 21-j is able to process, per unit time, more incoming calls than when a person acquires a requirement through listening. A further increase in the number of incoming calls which can be processed per unit time can be achieved by increasing the number of requirement input units 21-j, instead of increasing the number of staff members. Therefore, an increase in labor cost can be reduced. A time from an outgoing call made by a customer to acquisition of a requirement through listening is shortened, and therefore stress of the customer caused by wait time from an outgoing call to acquisition of a requirement through listening can be reduced.

The requirement input unit 21-j recognizes, based on requirement information, a content of an inquiry, retrieves an answer candidate from a question and answer (Q&A) table previously stored in the storage unit 25, and thereby may output a retrieved answer to the customer terminal 50.

The priority determination unit 22 determines, when an inquiry ID is notified from the requirement input unit 21-j, a priority of a response to an inquiry by an inquiry service person, based on requirement information of the inquiry indicated by the inquiry ID. A determination method for a priority is described later.

The list control unit 23 stores, in a standby list according to a determined priority, an inquiry ID of an inquiry for which a priority is determined. The standby list is a list of inquiry IDs of inquiries awaiting a response. The inquiry awaiting a response is an inquiry in which an inquiry has been made but a response has not yet been made. The standby list is provided for each priority. According to the present example embodiment, it is assumed that a priority includes four stages of A, B, C, and D, and a stage where a priority is highest is A and a stage where a priority is lowest is D. A priority of a common inquiry is D. It is assumed that four standby lists (La, Lb, Lc, and Ld) are stored in the storage unit 25. The list control unit 23 selects a standby list according to a determined priority. The list control unit 23 stores, in a selected standby list, an inquiry ID of an inquiry for which a priority is determined.

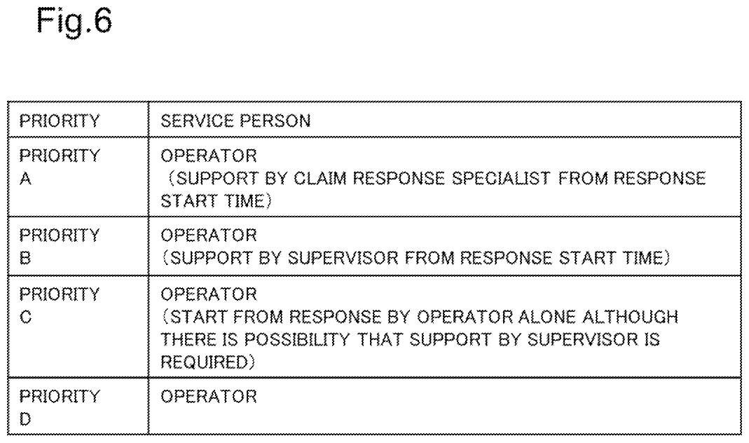

FIG. 6 illustrates an example of division of priorities. A priority A is a level where a claim response specialist performs support from a response start time. A priority B is a level where a supervisor performs support from a response start time. A priority C is a level where there is a possibility that support by a supervisor is required but start is done from a response by an operator alone. A priority D is a level where a response by an operator alone is not problematic. The supervisor plays a role in supporting a response to an inquiry having difficult in a response by an operator alone.

The display control unit 24 causes a display means to display a screen (a screen including a priority information image) providing priority information. The priority information indicates information relating to an inquiry indicated by an inquiry ID stored in each of standby lists. The priority information is, for example, an inquiry ID stored in each of the four standby lists. The priority information may be a part of inquiry IDs stored in the four standby lists each, for example, an inquiry ID stored in a part of the standby lists (e.g., only the standby list La or the like). The information relating to an inquiry may be information of a customer associated with an inquiry, for example, a customer ID, a contract ID, or the like.

According to the present example embodiment, the display means is a display means included in a display terminal. The display control unit 24 causes the display means included in the display terminal 70-i to display a screen including a priority information image when a display request for requesting display of the priority information image is input from the display terminal 70-i.

A service person operates the display terminal 70-i and causes the display terminal 70-I to display a screen including a priority information image. The service person operates the display terminal 70-i and selects an inquiry to be responded to. The service person may be any of an operator, a supervisor, and a claim response specialist.

According to the present example embodiment, as illustrated in FIG. 6, a main person of a response to an inquiry is an operator, and a supervisor and a claim service specialist support the operator. This aims to gain experience by the operator.

A service person selects an inquiry from among inquiries having high priority. The service person may select, from among inquiries having a priority which can be responded to by him/herself, an inquiry to be responded to. The display control unit 24 may narrow down inquiries (priorities) displayed in a priority information image, according to a priority which can be responded to by a service person associated with the display terminal 70-i.

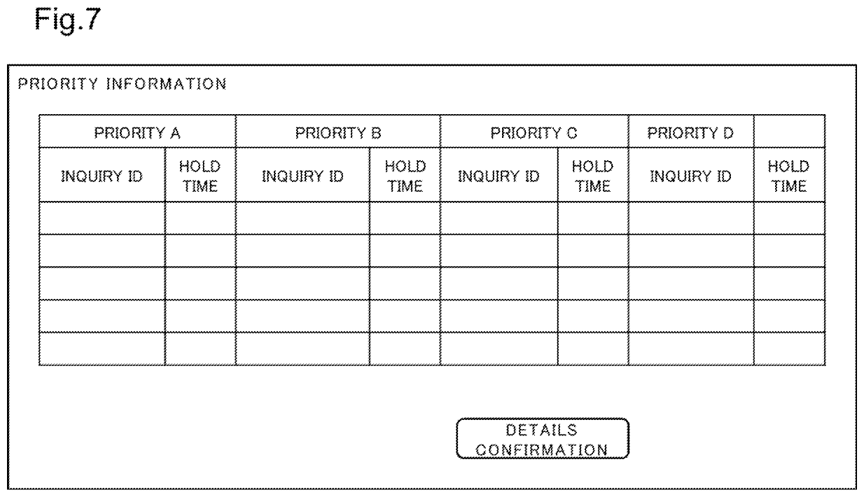

FIG. 7 illustrates an example of a priority information image. In the priority information image illustrated in FIG. 7, inquiry IDs stored in the standby lists La to Ld are displayed. The inquiry ID is displayed, for example, in an issuance order of an ID, a length order of a hold time, or the like.

In the priority information image, a hold time may be displayed for each inquiry ID. The hold time is an elapsed time from completion of questions and answers in the requirement input unit 21-j. Information of the hold time is included in a priority information image, and thereby a service person considers the hold time in addition to a priority and can select an inquiry to be responded to.

A screen item “details confirmation” is a screen item for confirming detail information of an inquiry. When an operation for selecting the screen item “details confirmation” is performed in the display terminal 70-i while an inquiry ID is selected, a display request for requesting display of a screen (a screen including an inquiry information image) providing inquiry information is input from the display terminal 70-i to the customer service assistance device 20. The display request incudes an inquiry ID of an inquiry to be displayed. When the display request for the inquiry information image is input, the display control unit 24 causes a display means included in the display terminal 70-i of a request source to display a screen including the inquiry information image of the inquiry to be displayed.

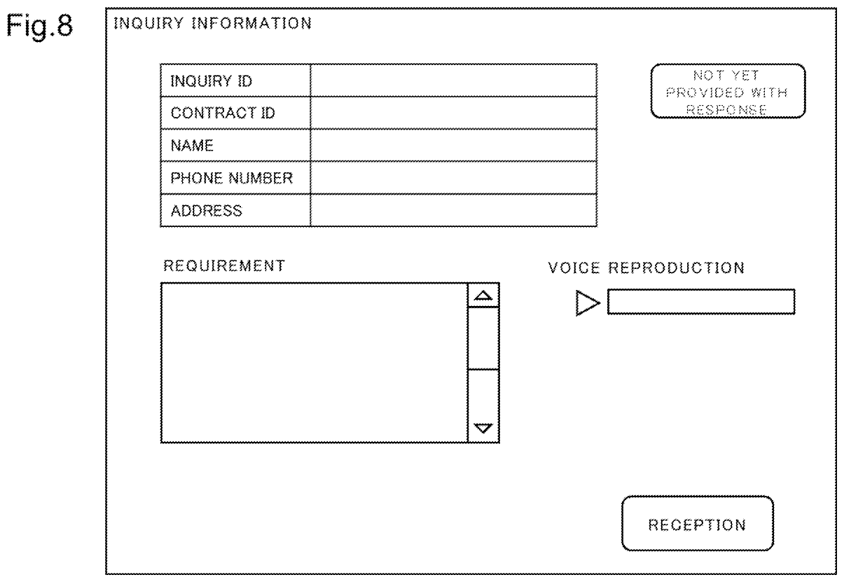

FIG. 8 illustrates an example of an inquiry information image. In the inquiry information image illustrated in FIG. 8, information relating to an inquiry to be displayed is displayed. The information relating to an inquiry includes an inquiry ID, customer information of a customer making an inquiry, and the like. In the inquiry information image, requirement information is displayed. Accuracy of conversion of a voice into characters is not 100%-guaranteed. Therefore, in the inquiry information image, a screen item for reproducing a voice at a time of questions and answers based on the requirement input unit 21-j is also displayed.

In the inquiry information image, a screen item “reception” for inputting, by a service person, an effect for responding to the inquiry is displayed. When an operation for selecting the screen item “reception” is performed, the display terminal 70-i inputs, to the customer service assistance device 20, a response processing request for requesting processing enabling a response. The response processing request indicates that the service person hopes a response to the inquiry.

The list control unit 23 acquires, when a response processing request is input from the display terminal 70-i, an inquiry ID of a target inquiry of a response processing request from a standby list. The list control unit 23 instructs the call control device 40 to transfer a call of the inquiry indicated by the inquiry ID to a transfer destination. The transfer destination is a phone call terminal 60-i associated with a display terminal 70-i being a request source of a response processing request. Information of an association relation between the phone call terminal 60-i and the display terminal 70-i is stored in the storage unit 25.

The list control unit 23 stores an inquiry ID of the inquiry in a response continuation list. The response continuation list stores an inquiry ID of an inquiry being responded to. The response continuation list is stored in the storage unit 25. The response continuation list is provided for each priority.

The list control unit 23 may issue a request to the call control device 40 in such a way that for an inquiry of a priority A or B, i.e., a support-required inquiry, a phone call among three persons being a support person, an operator, and a customer is made possible from at a response start time. The support person includes a supervisor or a claim response specialist.

The display control unit 24 causes, when, for example, a response processing request for an inquiry of a priority B is input, a display terminal of a supervisor to display a screen for requesting support. The list control unit 23 issues, when input indicating that support is possible is performed, a request to the call control device 40 in such a way that a phone call among a phone call terminal of a supervisor able to perform support, a phone call terminal 60-i of a service person, and the customer terminal 50 is made possible.

When a call for an inquiry is transferred to the phone call terminal 60-i, the display control unit 24 causes the display terminal 70-i to display a screen including a service person image. The service person image is an image providing information of an inquiry being responded to.

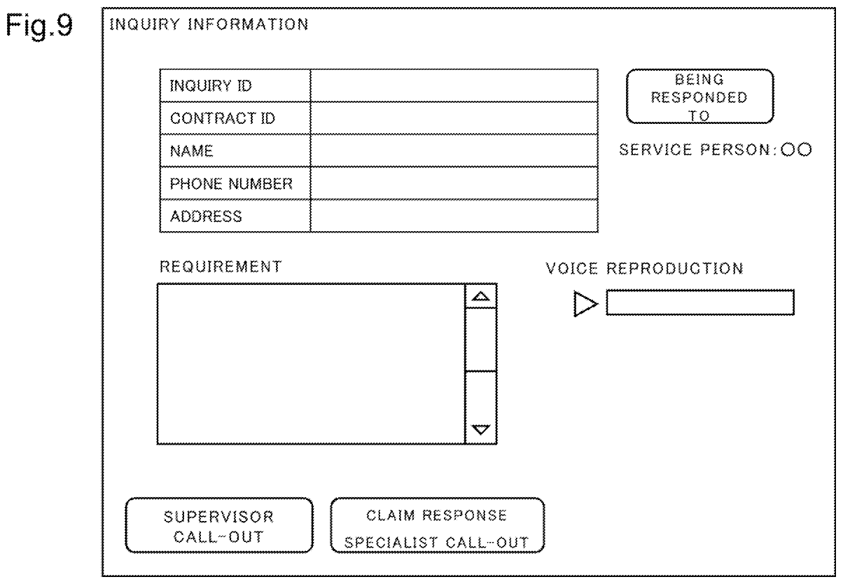

FIG. 9 illustrates a service person image. The service person image in FIG. 9 provides information relating to a customer, requirement information, and a screen item for reproducing a voice of questions and answers based on the requirement input unit 21-j. The service person image may include display indicating that the inquiry is being responded to and information indicating a service person being responding. The service person image may include a screen item “supervisor call-out” for requesting support from a supervisor and a screen item “claim response specialist call-out” for requesting support from a claim response specialist.

The display control unit 24 displays customer information in a service person image. The customer information is previously acquired, through listening, by the requirement input unit 21-j, converted into characters, and stored in the storage unit 25. The service person does not need to newly acquire, through listening, customer information and therefore, can confirm the customer information in a short time.

The display control unit 24 displays display requirement information in a service person image. For the requirement information, a requirement previously acquired, through listening, by the requirement input unit 21-j is converted into characters, and the generated characters are stored in the storage unit 25. Therefore, a service person can recognize a requirement and confirm a requirement for a customer in a short time.

In this manner, the requirement input unit 21-j previously acquires, through listening, information of a customer and a requirement and the display control unit 24 displays, in a service person image, customer information and requirement information, and thereby a response time of a service person can be shortened. The response time of the service person is shortened, and thereby wait time of the customer can be shortened.

The display control unit 24 may display, in a service person image, from among pieces of requirement information of past cases, requirement information of a past case having a high degree of similarity to requirement information of a target inquiry and information indicating a response having been provided for the past case. Requirement information of a past case and information indicating a past response are displayed in a service person image, and thereby a response load on a service person can be reduced.

The display control unit 24 may cause the display terminal 70-i to display a screen including a response continuation list image providing information of a list of an inquiry being responded to by any service person. A display destination of the response continuation list image is a display means of a device of a request source for display of the response continuation list image.

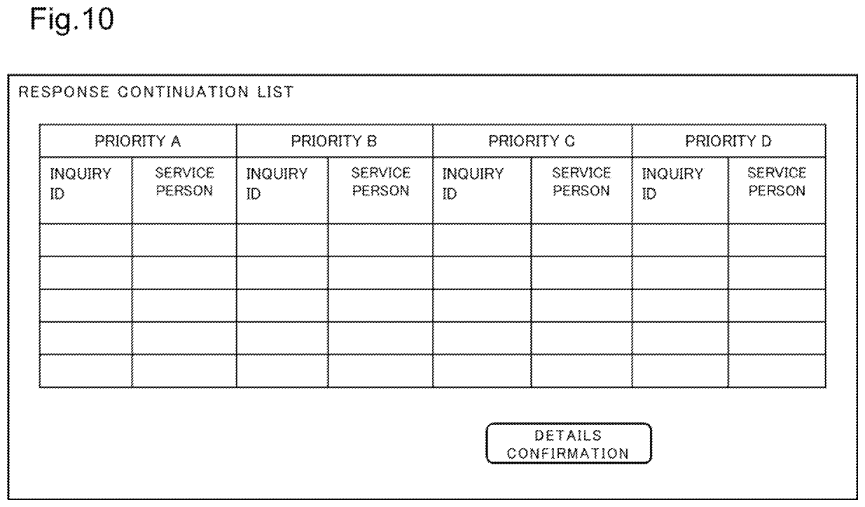

FIG. 10 illustrates an example of a response continuation list image. The response continuation list image provides an inquiry ID of an inquiry being responded to by any service person. The inquiry ID may be displayed for each priority, as illustrated in FIG. 10. The response continuation list image may include information (a service person ID and a name) of a service person being responding to an inquiry.

A screen item “details confirmation” is a screen item for confirming detail information of an inquiry. When an operation for selecting the screen item “details conformation” is performed by the display terminal 70- i while an inquiry ID is selected, a display request for requesting display of an image (response continuation detail image) providing inquiry information is input from the display terminal 70-i to the customer service assistance device 20. The display request includes an inquiry ID of an inquiry to be displayed. When the display request for the response continuation detail image is input, the display control unit 24 causes a display means included in a display terminal 70-i of a request source to display a screen including the response continuation detail image of the inquiry to be displayed.

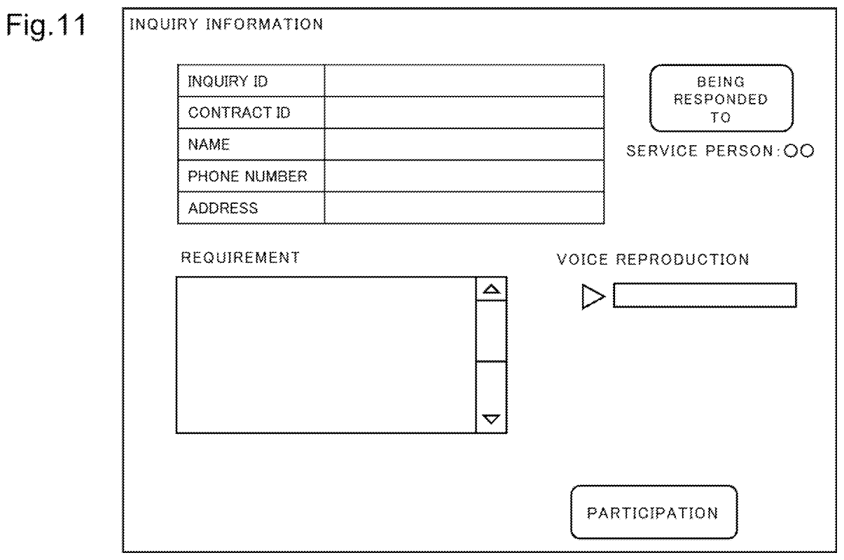

FIG. 11 illustrates an example of a response continuation detail image. In the response continuation detail image illustrated in FIG. 11, a screen item “participation” used for participation of another service person in an inquiry being responded to by another service person is displayed. The screen item “participation” is used when, for example, a supervisor or a claim response specialist supports an inquiry being responded to by an operator. When an operation for selecting the screen item “participation” is performed by the display terminal 70-i, a response processing request is input to the customer service assistance device 20. When the response processing request for the inquiry being responded to is input to the customer service assistance device 20, the list control unit 23 issues a request to the call control device 40 in such a way as to cause a phone call terminal 60-i associated with a display terminal 70-i of a request source to participate in a phone call for the target inquiry.

The response continuation detail image and the response continuation list image may include information of an emotion of a customer. The customer service assistance device 20, for example, monitors a phone call being responded to, recognizes a state of an emotion of a customer, and thereby may reflect information of the emotion of the customer in the response continuation detail image and the response continuation list image. Recognition of an emotion of a customer can be achieved by a method similar to a method to be described later. By doing so, a support person confirms a state of an emotion of a customer and thereby, can support a response.

Next, a determination method for a priority is described. The priority determination unit 22 determines a priority, for example, based on at least any one of a degree of similarity to requirement information of an inquiry made in a past, logicality of a requirement, or an emotion of a customer. The inquiry made in a past is referred to as a past case, and requirement information for the past case is referred to as past information. Herein, description is made for a case in which the priority determination unit 22 determines a priority, based on (1) a degree of similarity to past information, (2) logicality of a requirement, and (3) an emotion of a customer.

First, a determination method for (1) a degree of similarity to past information is described.

An inquiry ID is notified to the priority determination unit 22 from the requirement input unit 21-j. Requirement information associated with the notified inquiry ID, i.e., requirement information of an inquiry of this time (referred to as target requirement information) is stored in the storage unit 25. In addition, past information is stored in the storage unit 25. The priority determination unit 22 determines a degree of similarity, based on the target requirement information and the past information. According to the present example embodiment, it is assumed that the degree of similarity includes three stages being high, medium, and low.

The priority determination unit 22 calculates, for each of pieces of past information stored in the storage unit 25, a similarity indicator to target requirement information. The similarity indicator is an indicator indicating a degree of similarity. The similarity indicator is larger as more words matched between target requirement information and past information are present. Then, the priority determination unit 22 regards, as a similarity indicator of the target requirement information, a similarity indicator of past information a similarity indicator of which is largest. The priority determination unit 22 compares the similarity indicator with a predetermined threshold and thereby, determines a degree of similarity of the target requirement information as any of stages being high, medium, and low.

Next, a determination method for (2) logicality of a requirement is described.

The priority determination unit 22 determines, based on target requirement information, whether a requirement is logical or illogical. When the requirement includes a logical content being coherent, the requirement information is determined as being logical.

The priority determination unit 22 further determines, for the requirement information determined as being logical, whether the requirement is technical or non-technical. When, for example, a type number of a specific product, a keyword relating to an operation of a product such as a matter that “power is not supplied”, and the like are included in requirement information, the requirement information is determined as being technical. The priority determination unit 22 further determine, for each of pieces of requirement information, whether to be an unreasonable demand.

The priority determination unit 22, for example, uses, when requirement information is input, a logicality determination model that outputs a determination result for logicality and determines logicality. The logicality determination model is generated by learning learning information. Learning information of the logicality determination model includes requirement information of a past case and a determination result (correct answer information) for the requirement information of the past case. It is assumed that the logicality determination model is previously generated.

Next, a determination method for (3) an emotion of a customer is described.

The priority determination unit 22 determines an emotion of a customer, based on target requirement information and target voice information. The target voice information is voice information associated with an inquiry ID notified from the requirement input unit 21-j. The target voice information is stored in the storage unit 25.

The priority determination unit 22 determines an emotion of a customer as being normal or abnormal. Determination that an emotion is abnormal indicates a case in which an emotion is increasing. The priority determination unit 22 determines that an emotion is abnormal when, for example, a predetermined keyword is included in target requirement information. The priority determination unit 22 determines an emotion, for example, based on characteristics (a tone of a voice, a speaking speed, and the like) of a voice indicated by target voice information. The priority determination unit 22 may determine an emotion, by using an emotion determination model. The emotion determination model outputs, when target voice information input, a determination result of an emotion. Learning information of the emotion determination model includes voice information and a determination result (correct answer information) of an emotion for the voice information.

The priority determination unit 22 may use, for emotion determination, information of a customer making an inquiry to be determined. It is assumed that, for example, a list of information indicating a customer having been emotional about a past inquiry is stored in the storage unit 25. The priority determination unit 22 determines, when it is difficult to clearly determine whether an emotion is normal or abnormal (e.g., a case in which an evaluation value of emotion determination is close to a threshold), an inquiry, when being an inquiry from a customer having been emotional in a past, as being abnormal.

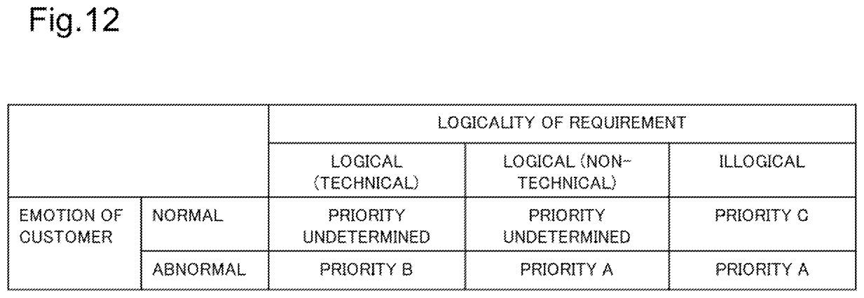

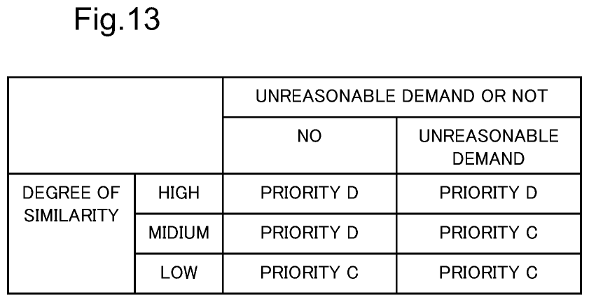

The priority determination unit 22 determines a priority, based on determination results in (1) to (3), for example, as described below. FIG. 12 and FIG. 13 illustrate an example of a determination rule for a priority.

First, the priority determination unit 22 determines a priority, based on (2) logicality of a requirement and (3) an emotion of a customer (FIG. 12). When an emotion of a customer is abnormal, a degree of difficulty in a response is high, compared with being normal. Therefore, it is highly likely that support of a supervisor or a claim response specialist is required from an initial stage of a response. Therefore, the priority determination unit 22 determines, when an emotion of a customer is abnormal, a priority as A or B.

When an emotion of a customer is normal and a requirement is illogical, a degree of difficulty is medium and therefore, it is likely that support of a claim response specialist is required. Therefore, in this case, the priority determination unit 22 determines, as C, a priority of a target inquiry. When an emotion of a customer is normal and a requirement is logical, necessity of support for an operator changes according to a degree of similarity to a past case. Therefore, in this case, the priority determination unit 22 once causes a priority of a target inquiry to be undetermined.

When an emotion of a customer is abnormal and a requirement is illogical, a degree of difficulty is high and therefore, it is highly likely that support of a claim response specialist is required. Therefore, in this case, the priority determination unit 22 determines, as A, a priority of a target inquiry. When an emotion of a customer is abnormal and a requirement is logical and technical, a degree of difficulty is high and therefore, it is highly likely that support of a supervisor is required. Therefore, in this case, the priority determination unit 22 determines, as B, a priority of a target inquiry. When an emotion of a customer is abnormal and a requirement is logical and non-technical, a degree of difficulty is high and therefore, it is highly likely that support of a claim response specialist is required. Therefore, in this case, the priority determination unit 22 determines, as A, a priority of a target inquiry.

When an emotion of a customer is normal and a requirement is logical, the priority determination unit 22 determines a priority, further, based on (1) a degree of similarity to past information (FIG. 13). When a degree of similarity to past information is high, a degree of difficulty is low and therefore, it is unlikely that support of s supervisor or a claim response specialist is required. Therefore, in this case, the priority determination unit 22 determines, as D, a priority of a target inquiry. When a degree of similarity to past information is low, a degree of difficulty and a possibility that support of s supervisor or a claim response specialist is required increase. However, an emotion of a customer is normal, and therefore a degree of difficulty is low, compared with a case in which an emotion of a customer is abnormal. Therefore, in this case, the priority determination unit 22 determines, as C, a priority of a target inquiry.

When a degree of similarity to past information is medium, the priority determination unit 22 determines a priority, further, based on whether a requirement is an unreasonable demand. When the requirement is not an unreasonable demand, a degree of difficulty is low and therefore, it is also unlikely that support for an operator is required. Therefore, the priority determination unit 22 determines, as D, a priority of a target inquiry. When a requirement is an unreasonable demand, a degree of difficult increases and therefore, it is also likely that support of a supervisor is required. Therefore, the priority determination unit 22 determines, as C, a priority of a target inquiry.

When the customer service assistance device 20 is configured in this manner, the priority determination unit 22 determines, based on requirement information, a priority of a response to an inquiry. The list control unit 23 stores identification information of an inquiry for which a priority is determined in a standby list according to the determined priority. The display control unit 24 causes the display means to display a screen providing priority information. Thereby, based on priority information, a service person can select an inquiry to be responded to, and therefore an inquiry having high priority is preferentially responded to. An inquiry in which wait time is prolonged and as a result, a degree of customer satisfaction is highly likely to decrease is preferentially responded to as an inquiry having high priority. Therefore, a decrease in a degree of customer satisfaction caused by wait time from an inquiry made by a customer to a response made by a service person can be reduced.

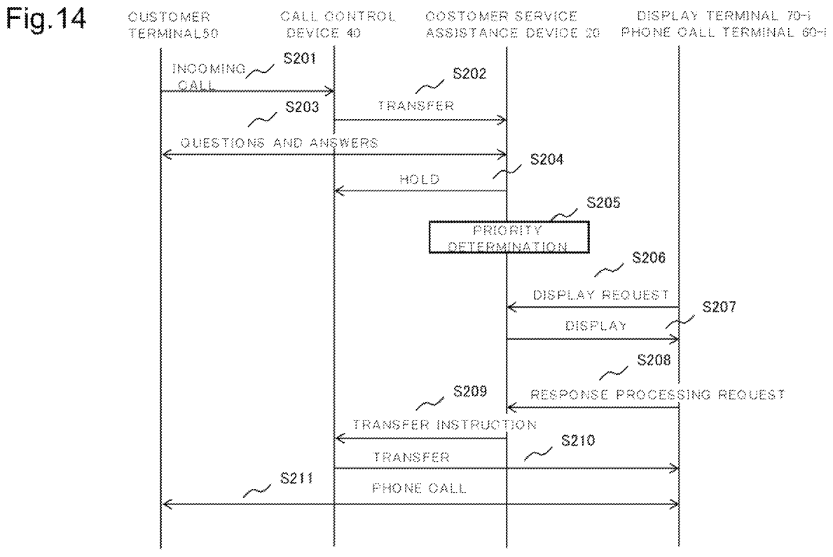

Next, FIG. 14 illustrates an outline of an operation example of a system including the customer service assistance device 20 according to the present example embodiment.

The call control device 40 transfers, when there is an incoming call from the customer terminal 50 (step S201), the call to the customer service assistance device 20 (step S202).

The requirement input unit 21-j of the customer service assistance device 20 performs questions and answers to the customer terminal 50 and prompts a customer to input a requirement (step S203). The requirement input unit 21-j issues an inquiry ID, associates the inquiry ID with inquiry information, and stores, in the storage unit 25, the associated inquiry ID and inquiry information. The inquiry information is information relating to an inquiry. The requirement input unit 21-j instructs, when the questions and answers are completed, the call control device 40 to hold the call (step S204).

The priority determination unit 22 of the customer service assistance device 20 determines, based on requirement information of the inquiry, a priority of a response of a service person to the inquiry (step S205).

The display control unit 24 of the customer service assistance device 20 causes, when a display request for requesting display of a priority information image is input from the display terminal 70-i (step S206), a display means included in the display terminal 70-i to display a screen including the priority information image (step S207).

The list control unit 23 of the customer service assistance device 20 acquires, when a response processing request is input from the display terminal 70-i, an inquiry ID of a target inquiry of the response processing request from a standby list. The list control unit 23 instructs the call control device 40 to transfer a call of an inquiry indicated by the inquiry ID to a transfer destination (step S209). The transfer destination is a phone call terminal 60-i associated with the display terminal 70-i.

The call control device 40 transfers, when receiving a transfer instruction of a call to the phone call terminal 60-i from the customer service assistance device 20, a call to be transferred to the specified phone call terminal 60-i (step S210). Thereby, a phone call between the customer terminal 50 of the customer and the phone call terminal 60-i of the service person is made possible (step S211).

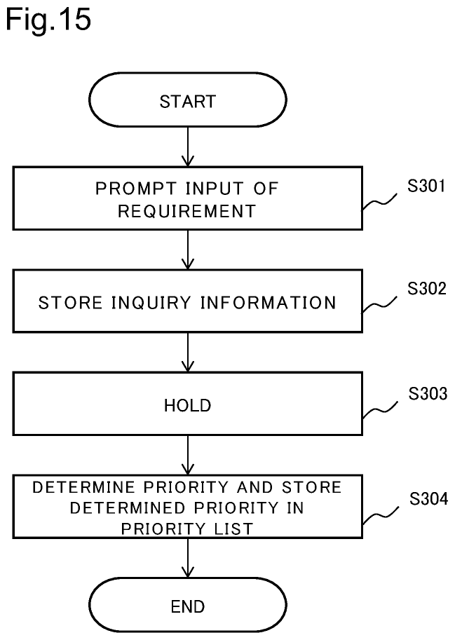

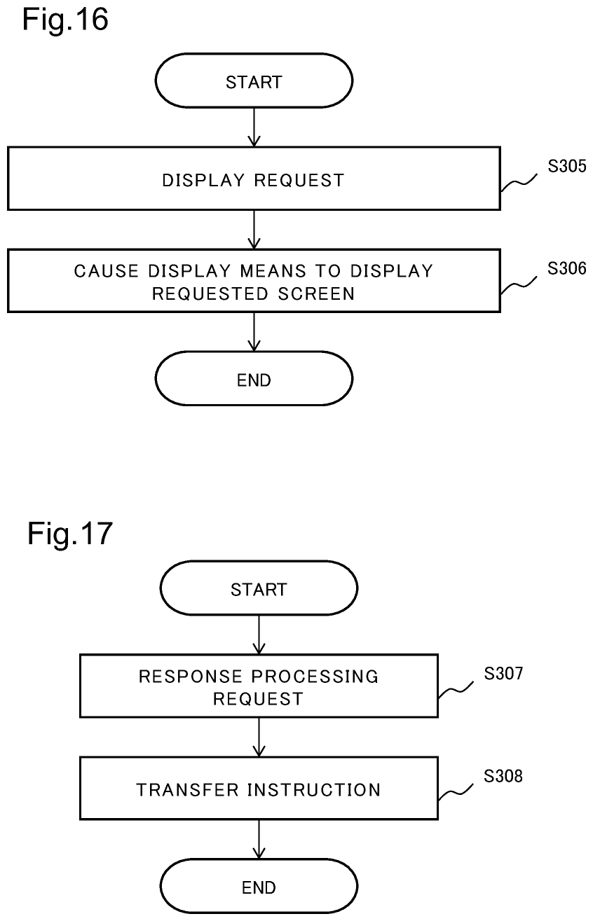

Next, FIG. 15 to FIG. 17 illustrate operation examples of the customer service assistance device 20 according to the present example embodiment. FIG. 15 illustrates an operation example of the customer service assistance device 20 in a case of transfer of a call. FIG. 16 illustrates an operation example of the customer service assistance device 20 in a case of input of a display request of a screen. FIG. 17 illustrates an operation example of the customer service assistance device 20 in a case of input of a response processing request.

The selection unit 26 selects, when a call is transferred from the call control device 40, a unit being not handling a call from among the requirement input unit 21-1 to the requirement input unit 21-M. The selection unit 26 transfers the call to the selected requirement input unit 21-j.

The requirement input unit 21-j prompts, when the call is transferred, a customer to input a customer ID and a requirement (step S301). The requirement input unit 21-j issues identification information (inquiry ID) of the inquiry, associates the inquiry ID with inquiry information, and stores, in the storage unit 25, the associated inquiry ID and inquiry information (step S302). The requirement input unit 21-j notifies the priority determination unit 22 of the inquiry ID. The requirement input unit 21-j instructs, when questions and answers are completed, the call control unit 40 to hold the call (step S303).

The priority determination unit 22 determines, when the inquiry ID is notified from the requirement input unit 21-j, based on requirement information of an inquiry indicated by the inquiry ID, a priority of a response of a service person to the inquiry. The list control unit 23 stores an inquiry ID of an inquiry for which a priority is determined in a standby list according to the determined priority (step S304).

The display control unit 24 causes, when a display request for requesting display of a priority information image is input from the display terminal 70-i (step S305), a display means included in the display terminal 70-i to display a screen including the priority information image (step S306).

The list control unit 23 acquires, when a response processing request is input from the display terminal 70-i (step S307), an inquiry ID of a target inquiry of the response processing request from the standby list. The list control unit 23 instructs the call control device 40 to transfer a call of an inquiry indicated by the inquiry ID to a transfer destination (step S308). The transfer destination is a phone call terminal 60-i associated with the display terminal 70-i of a request source of the response processing request.

The customer service assistance device 20 operates in this manner and thereby, determines, based on requirement information, a priority of a response to an inquiry. The customer service assistance device 20 stores identification information of an inquiry for which a priority is determined in a standby list according to the determined priority. The customer service assistance device 20 causes a display means to display a screen providing priority information. Therefore, a decrease in a degree of customer satisfaction caused by wait time from an inquiry made by a customer to a response made by a service person can be reduced

As described above, according to the second example embodiment of the present invention, the customer service assistance device 20 includes the priority determination unit 22, the list control unit 23, and the display control unit 24. The priority determination unit 22 determines, based on requirement information, a priority of a response to an inquiry. The list control unit 23 stores identification information of an inquiry for which a priority is determined in a standby list according to the determined priority. The display control unit 24 causes a display means to display a screen providing priority information. Thereby, based on the priority information, a service person can select an inquiry to be responded to, and therefore an inquiry having high priority is preferentially responded to. An inquiry in which wait time is prolonged and as a result, a degree of customer satisfaction is highly likely to decrease is preferentially responded to as an inquiry having high priority. Therefore, a decrease in a degree of customer satisfaction caused by wait time from an inquiry made by a customer to a response made by a service person can be reduced.

According to the present example embodiment, the customer service assistance device 20 acquires, when a response processing request for requesting processing enabling a response is input, identification information of a target inquiry of the response processing request from a standby list. Thereby, the customer service assistance device 20 is able to cause the standby list to be in a state where identification information of an inquiry awaiting a response is stored.

According to the present example embodiment, the customer service assistance device 20 includes the requirement input unit 21-j. The requirement input unit 21-j prompts a customer to input a requirement by using AI or the like. Therefore, it is possible to process, per unit time, more incoming calls than when a person acquires, through listening, a requirement. Further, an increase in labor cost can be reduced. A time from an outgoing call made by a customer to acquisition of a requirement through listening is shortened, and therefore stress of the customer caused by wait time from an outgoing call to acquisition of a requirement through listening can be reduced.

According to the present example embodiment, requirement information may be a requirement input with characters. Thereby, the customer service assistance device 20 is able to assist a response to an inquiry based on a web or chat.

According to the present example embodiment, the requirement input unit 21-j converts a requirement input with a voice into characters and thereby, generates requirement information. Thereby, the customer service assistance device 20 is able to assist a response to an inquiry based on a phone call.

According to the present example embodiment, a priority may be based on any one or more of a degree of similarity between requirement information of an inquiry of this time and requirement information of an inquiry made in a past, an emotion of a customer discriminated based on requirement information, and logicality of a requirement indicated by requirement information. Thereby, the customer service assistance device 20 is able to determine, based on these pieces of information, an inquiry to be preferentially responded to. A priority of an inquiry having a high degree of difficulty, for example, such as an inquiry having a low degree of similarity to past information, an inquiry in which a customer is emotional, and an illogical inquiry is caused to be higher, and thereby such an inquiry can be preferentially responded to.

According to the present example embodiment, the display control unit 24 causes a display means to display a screen providing information of a past case having a high degree of similarity. Thereby, a service person can respond to an inquiry while viewing information of a past case. Therefore, a time spent in a response to an inquiry can be shortened.

According to the present example embodiment, the list control unit 23 instructs, when a response processing request is input, the call control device to transfer a call for a target inquiry of a response processing request to a transfer destination. The transfer destination is a phone call terminal associated with a terminal of a request source of the response processing request. Thereby, processing enabling a response for a customer can be executed by the customer service assistance device 20.

According to the present example embodiment, the display control unit 24 causes a display means to display a screen providing requirement information. Thereby, a service person can recognize a requirement and confirm a requirement for a customer in a short time.

### Hardware Configuration Example

A configuration example of hardware resources for achieving, by using one information processing device (computer), the customer service assistance device (10 and 20) according to the example embodiments of the present invention described above is described. The customer service assistance device may be achieved by physically or functionally using at least two information processing devices. The customer service assistance device may be achieved as a dedicated device. Only a part of the customer service assistance device may be achieved by using the information processing device.

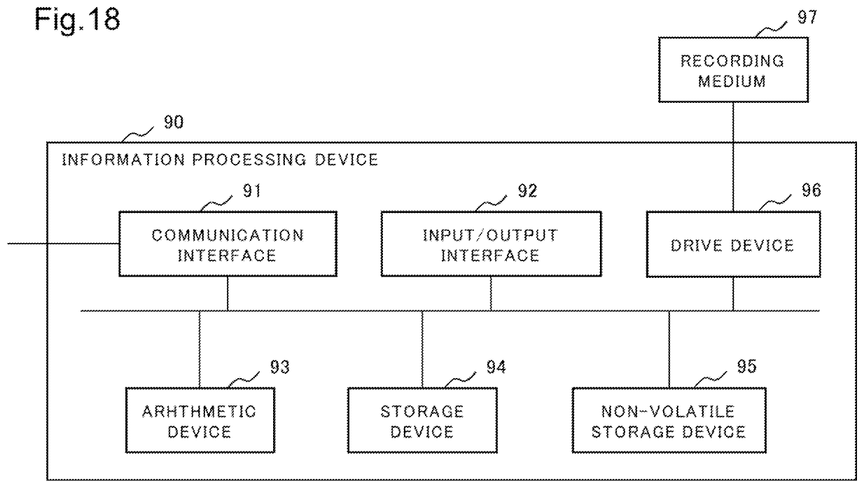

FIG. 18 is a diagram schematically illustrating a hardware configuration example of an information processing device capable of achieving the customer service assistance device according to each example embodiment of the present invention. An information processing device 90 includes a communication interface 91, an input/output interface 92, an arithmetic device 93, a storage device 94, a non-volatile storage device 95, and a drive device 96.

The priority determination unit 12, the list control unit 13, and the display control unit 14 in FIG. 1 can be achieved, for example, by using the arithmetic device 93 and the input/output interface 92.

The communication interface 91 is a communication means for communicating with an external device, based on a wire or/and wireless mode, by the customer service assistance device according to each example embodiment. When the customer service assistance device is achieved by using at least two information processing devices, these devices may be connected mutually communicably via the communication interface 91.

The input/output interface 92 is a man-machine interface such as a keyboard being one example of an input device and a display as an output device.

The arithmetic device 93 is achieved by using an arithmetic processing device such as a general-purpose central processing unit (CPU) and a microprocessor and a plurality of electric circuits. The arithmetic device 93 reads various types of programs stored, for example, in the non-volatile storage device 95 onto the storage device 94 and is able to execute processing in accordance with the read programs.

The storage device 94 is a memory device such as a random access memory (RAM) that can be referred to from the arithmetic device 93 and stores a program and various types of data. The storage device 94 may be a volatile memory device.

The non-volatile storage device 95 is a non-volatile storage device, for example, such as a read only memory (ROM) and a flash memory and is able to store various types of programs, data, and the like.

The drive device 96 is, for example, a device that executes processing of reading and writing data for a recording medium 97 to be described later.

The recording medium 97 is any data-recordable recording medium, for example, such as an optical disc, a magneto optical disc, and a semiconductor flash memory.

According to each example embodiments of the present invention, the customer service assistance device is configured, for example, based on the information processing device 90 illustrated in FIG. 18 and may be achieved by supplying, to the customer service assistance device, a program capable of achieving the function described according to each example embodiment.

In this case, the program supplied to the customer service assistance device is executed by the arithmetic device 93, and thereby an example embodiment can be achieved. Instead of the entire customer service assistance device, a partial function may be configured by using the information processing device 90.

A configuration may be made in such a way that the program is recorded on the recording medium 97 and in a shipment stage or an operation stage of the customer service assistance device, the program is appropriately stored in the non-volatile storage device 95. In this case, for a supply method for the program, a method of installation into the customer service assistance device using an appropriate tool in a production stage prior to shipment, an operation stage, or the like is employable. In addition, for a supply method for the program, a common procedure such as a method of download from an outside via a communication line such as the Internet is employable

The whole or part of the example embodiments disclosed above can be described as, but not limited to, the following Supplementary notes.

### Supplementary Note 1

A customer service assistance device comprising:
a priority determination means for determining, based on requirement information indicating a requirement of an inquiry from a customer, a priority of a response to the inquiry;
a list control means for storing identification information of the inquiry for which the priority is determined in a standby list according to the determined priority, the standby list being a list of the identification information of the inquiry awaiting a response, from among standby lists provided for each of the priority; and
a display control means for causing a display means to display a screen providing priority information indicating the identification information stored in each of the standby lists.

### Supplementary Note 2

The customer service assistance device according to Supplementary note 1, further comprising
a requirement input means for prompting the customer to input the requirement.

### Supplementary Note 3

The customer service assistance device according to Supplementary note 2, wherein
the requirement information is the requirement being input with characters.

### Supplementary Note 4

The customer service assistance device according to Supplementary note 2 or 3, wherein
the requirement input means generates the requirement information by converting a requirement being input with a voice into characters.

### Supplementary Note 5

The customer service assistance device according to any one of Supplementary notes 1 to 4, wherein
the priority is based on at least any one of a degree of similarity between the requirement information of the inquiry at this time and the requirement information of the inquiry made in a past, an emotion of the customer being discriminated based on the requirement information, and logicality of the requirement indicated by the requirement information.

### Supplementary Note 6

The customer service assistance device according to Supplementary note 5, wherein
the display control means causes the display means to display a screen providing information of a past case having a high degree of similarity.

### Supplementary Note 7

The customer service assistance device according to any one of Supplementary notes 1 to 6, wherein
the list control means further acquires, when a response processing request for requesting processing enabling the response is input, the identification information of the inquiry being a target of the response processing request from the standby list.

### Supplementary Note 8

The customer service assistance device according to Supplementary note 7, wherein
the list control means instructs, when the response processing request is input, a call control device that controls a transfer destination of a call in such a way as to transfer a call of the inquiry being a target of the response processing request to a phone call terminal associated with a terminal of a request source of the response processing request.

### Supplementary Note 9

The customer service assistance device according to any one of Supplementary notes 1 to 8, wherein
the display control means causes the display means to display a screen providing the requirement information.

### Supplementary Note 10

A customer service assistance method comprising:
determining, based on requirement information indicating a requirement of an inquiry from a customer, a priority of a response to the inquiry;
storing identification information of the inquiry for which the priority is determined in a standby list according to the determined priority, the standby list being a list of the identification information of the inquiry awaiting a response, from among standby lists provided for each of the priority; and
causing a display means to display a screen providing priority information indicating the identification information stored in each of the standby lists.

### Supplementary Note 11

The customer service assistance method according to Supplementary note 10, further comprising
prompting the customer to input the requirement.

### Supplementary Note 12

The customer service assistance method according to Supplementary note 11, wherein
the requirement information is the requirement being input with characters.

### Supplementary Note 13

The customer service assistance method according to Supplementary note 11 or 12, further comprising
generating the requirement information by converting the requirement being input with a voice into characters.

### Supplementary Note 14

The customer service assistance method according to any one of Supplementary notes 10 to 13, wherein
the priority is based on at least any one of a degree of similarity between the requirement information of the inquiry at this time and the requirement information of the inquiry made in a past, an emotion of the customer being discriminated based on the requirement information, and logicality of the requirement indicated by the requirement information.

### Supplementary Note 15

The customer service assistance method according to Supplementary note 14, further comprising
causing the display means to display a screen providing information of a past case having a high degree of similarity.

### Supplementary Note 16

The customer service assistance method according to any one of Supplementary notes 10 to 15, further comprising
acquiring, when a response processing request for requesting processing enabling the response is input, the identification information of the inquiry being a target of the response processing request from the standby list.

### Supplementary Note 17

The customer service assistance method according to Supplementary note 16, further comprising
instructing, when the response processing request is input, a call control device that controls a transfer destination of a call in such a way as to transfer a call of the inquiry being a target of the response processing request to a phone call terminal associated with a terminal of a request source of the response processing request

### Supplementary Note 18

The customer service assistance method according to any one of Supplementary notes 10 to 17, further comprising
causing the display means to display a screen providing the requirement information.

### Supplementary Note 19

A computer-readable recording medium recording a customer service assistance program causing a computer to achieve:
a priority determination function of determining, based on requirement information indicating a requirement of an inquiry from a customer, a priority of a response to the inquiry;
a list control function of storing identification information of the inquiry for which the priority is determined in a standby list according to the determined priority, the standby list being a list of the identification information of the inquiry awaiting a response, from among standby lists provided for each of the priority; and
a display control function of causing a display means to display a screen providing priority information indicating the identification information stored in each of the standby lists.

### Supplementary Note 20

The computer-readable recording medium recording the customer service assistance program according to Supplementary note 19, further causing a computer to achieve
a requirement input function of prompting the customer to input the requirement.

### Supplementary Note 21

The computer-readable recording medium recording the customer service assistance program according to Supplementary note 20, wherein
the requirement information is the requirement being input with characters.

### Supplementary Note 22

The computer-readable recording medium recording the customer service assistance program according to Supplementary note 20 or 21, wherein
the requirement input generates the requirement information by converting the requirement being input with a voice into characters.

### Supplementary Note 23

The computer-readable recording medium recording the customer service assistance program according to any one of Supplementary notes 19 to 22, wherein
the priority is based on at least any one of a degree of similarity between the requirement information of the inquiry at this time and the requirement information of the inquiry made in a past, an emotion of the customer being discriminated based on the requirement information, and logicality of the requirement indicated by the requirement information.

### Supplementary Note 24

The computer-readable recording medium recording the customer service assistance program according to Supplementary note 23, wherein
the display control function causes the display means to display a screen providing information of a past case having a high degree of similarity.

### Supplementary Note 25

The computer-readable recording medium recording the customer service assistance program according to any one of Supplementary notes 19 to 24, wherein
the list control function acquires, when a response processing request for requesting processing enabling the response is input, the identification information of the inquiry being a target of the response processing request from the standby list.

### Supplementary Note 26

The computer-readable recording medium recording the customer service assistance program according to Supplementary note 25, wherein
the list control function instructs, when the response processing request is input, a call control device that controls a transfer destination of a call in such a way as to transfer a call of the inquiry being a target of the response processing request to a phone call terminal associated with a terminal of a request source of the response processing request.

### Supplementary Note 27

The computer-readable recording medium recording the customer service assistance program according to any one of Supplementary notes 19 to 26, wherein
the display control function causes the display means to display a screen providing the requirement information.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

10, 20 customer service assistance device
12, 22 priority determination unit
13, 23 list control unit
14, 24 display control unit
21-j requirement input unit
25 storage unit
26 selection unit
40 call control device
50 customer terminal
60-i phone call terminal
70-i display terminal
90 information processing device
91 communication interface
92 input/output interface
93 arithmetic device
94 storage device
95 non-volatile storage device
96 drive device
97 recording medium

What is claimed is:

1. A customer service assistance device comprising one or more memories storing instructions and one or more processors configured to execute the instructions to:
determine, based on requirement information indicating a requirement of an inquiry from a customer, a priority of a response to the inquiry;
store identification information of the inquiry for which the priority is determined in a standby list according to the determined priority, the standby list being a list of the identification information of the inquiry awaiting a response, from among standby lists provided for each of the priority; and
cause display means to display a screen providing priority information indicating the identification information stored in each of the standby lists

2. The customer service assistance device according to claim 1, wherein
the one or more processors are configured to execute the instructions to prompt the customer to input the requirement.

3. The customer service assistance device according to claim 2, wherein
the requirement information is the requirement being input with characters.

4. The customer service assistance device according to claim 2, wherein
the one or more processors are configured to execute the instructions to generate the requirement information by converting the requirement being input with a voice into characters.

5. The customer service assistance device according to claim 1, wherein
the priority is based on at least any one of a degree of similarity between the requirement information of the inquiry at this time and the requirement information of the inquiry made in a past, an emotion of the customer being discriminated based on the requirement information, and logicality of the requirement indicated by the requirement information.

6. The customer service assistance device according to claim 5, wherein
the one or more processors are configured to execute the instructions to cause the display means to display a screen providing information of a past case having a high degree of similarity.

7. The customer service assistance device according to claim 1, wherein
the one or more processors are configured to execute the instructions to acquire, when a response processing request for requesting processing enabling the response is input, the identification information of the inquiry being a target of the response processing request from the standby list.

8. The customer service assistance device according to claim 7, wherein
the one or more processors are configured to execute the instructions to instruct, when the response processing request is input, a call control device that controls a transfer destination of a call in such a way as to transfer a call of the inquiry being a target of the response processing request to a phone call terminal associated with a terminal of a request source of the response processing request.

9. The customer service assistance device according to claim 1, wherein
the one or more processors are configured to execute the instructions to cause the display means to display a screen providing the requirement information.

10. A customer service assistance method comprising:
determining, based on requirement information indicating a requirement of an inquiry from a customer, a priority of a response to the inquiry;
storing identification information of the inquiry for which the priority is determined in a standby list according to the determined priority, the standby list being a list of the identification information of the inquiry awaiting a response, from among standby lists provided for each of the priority; and
causing display means to display a screen providing priority information indicating the identification information stored in each of the standby lists.

11. The customer service assistance method according to claim 10, further comprising prompting the customer to input the requirement.

12. The customer service assistance method according to claim 11, wherein
the requirement information is the requirement being input with characters.

13. The customer service assistance method according to claim 11, further comprising
generating the requirement information by converting the requirement being input with a voice into characters.

14. The customer service assistance method according to claim 10, wherein
the priority is based on at least any one of a degree of similarity between the requirement information of the inquiry at this time and the requirement information of the inquiry made in a past, an emotion of the customer being discriminated based on the requirement information, and logicality of the requirement indicated by the requirement information.

15. The customer service assistance method according to claim 14, further comprising causing the display means to display a screen providing information of a past case having a high degree of similarity.

16. The customer service assistance method according to claim 10, further comprising
acquiring, when a response processing request for requesting processing enabling the response is input, the identification information of the inquiry being a target of the response processing request from the standby list.

17. The customer service assistance method according to claim 16, further comprising
instructing, when the response processing request is input, a call control device that controls a transfer destination of a call in such a way as to transfer a call of the inquiry being a target of the response processing request to a phone call terminal associated with a terminal of a request source of the response processing request.

18. The customer service assistance method according to claim 10, further comprising
causing the display means to display a screen providing the requirement information.

19. A non-transitory computer-readable recording medium recording a customer service assistance program causing a computer to achieve:
a priority determination function of determining, based on requirement information indicating a requirement of an inquiry from a customer, a priority of a response to the inquiry;
a list control function of storing identification information of the inquiry for which the priority is determined in a standby list according to the determined priority, the standby list being a list of the identification information of the inquiry awaiting a response, from among standby lists provided for each of the priority; and
a display control function of causing display means to display a screen providing priority information indicating the identification information stored in each of the standby lists.

20. The non-transitory computer-readable recording medium recording the customer service assistance program according to claim 19, further causing a computer to achieve
a requirement input function of prompting the customer to input the requirement.

21-27. (canceled)
